(19) United States
(12) Patent Application Publication
(10) Pub. No.: US 2010/0142059 A1
(43) Pub. Date: Jun. 10, 2010

(54) LIQUID OPTICAL LENS AND LIQUID OPTICAL LENS MODULES

(75) Inventors: Chun-Hung Chou, Tainan County (TW); Yu-Liang Chung, Taipei City (TW); Horn-Sen Tzou, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: INDUSTRIAL TECHNOLOGY RESEARCH INSTITUTE, Hsinchu (TW)

(21) Appl. No.: 12/426,297

(22) Filed: Apr. 20, 2009

(30) Foreign Application Priority Data
Dec. 9, 2008 (TW) 97147875

(51) Int. Cl. G02B 3/14; G02B 1/06

(52) U.S. Cl. 359/666

(57) ABSTRACT

A liquid optical lens, including a transparent container, an elastic membrane, a first liquid and a second liquid, is provided. The transparent container is divided into a first chamber and a second chamber by the elastic membrane. The first liquid fills the first chamber. The second liquid fills the second chamber. The curvature of the elastic membrane is regulated by changing the volume ratio between the first liquid and the second liquid, so as to adjust the focal length of the liquid optical lens. Moreover, a liquid optical lens module including the above liquid optical lens and a volume adjustment mechanism is also provided. The focal length of the liquid optical lens can be precisely adjusted by using the volume adjustment mechanism.

### CROSS-REFERENCE TO RELATED APPLICATION

This application claims the priority benefit of Taiwan application serial no. 97147875, filed on Dec. 9, 2008. The entirety of the above-mentioned patent application is hereby incorporated by reference herein and made a part of specification.

### BACKGROUND OF THE INVENTION

1. Field of the Invention

The present invention relates to an optical lens and an optical lens module. More particularly, the present invention relates to a liquid optical lens and a liquid optical lens module.

2. Description of Related Art

Lens modules, applied in digital camera and camera phone industries, need a precise and compact lens focus positioning device. Well-known international companies such as Samsung, Seiko, Epson, Varioptic and Squiggle have established numerous researches on the development of the lens focus positioning device. Currently, the driving modes of the lens focus positioning device can be classified into four types, such as step motors, voice coil motors, piezoelectric motors, and liquid zooming.

The conventional step motors used to drive the lens focus positioning device have many problems, such as large volume, complicated mechanism, loud noise, slow zooming speed, high electricity consumption (about 300 mW to 600 mW) and high price, all of which make them unsuitable for current use.

Recently, the voice coil motors are mostly used to drive lens focus positioning device. The voice coil motors do not require gears and have simple mechanisms. However, the electricity consumption is still high when the voice coil motors are used to position the lens for a long period. Moreover, the voice coil motors need to cooperate with a lens moving device and require preserved space for lens movement. Thus, the miniaturization of the optical lens modules is unfavorable.

The piezoelectric motors can raise the positioning precision of the lens focus positioning device to a nano-meter level. The U.S. Pat. No. 6,940,209 with the title “ULTRASONIC LEAD SCREW MOTOR” of the Squiggle Company proposed a piezoelectric motor which is composed of nuts, screws, and four piezoelectric actuators. The alternated electrical driving signals are applied to the piezoelectric actuator to make the screws move, such that the lens movement is promoted. The power consumption level of this piezoelectric motor is lower (20 mW-100 mW). Furthermore, the U.S. Pat. No. 7,119,476 with the title “PIEZOELECTRIC ACTUATOR AND DEVICE” of the Seiko Epson Company proposed another piezoelectric motor which utilizes a layered structure formed by clamping a metal plate and an elastic board with piezoelectric elements. After a current is given, the elastic board bends to rotate a cam so as to make a lens move back and forth. However, the aforementioned zooming driving mode using the piezoelectric motor still needs lens movement and consequently cooperation with the lens moving elements. More specifically, the lens moving space needs to be disposed firstly, which has an adversely effect on the miniaturization of the optical lens modules.

Liquid zooming has many advantages, such as fast response speed, good light transmitting ability, low price, etc. In addition, the liquid zooming has the least number of mechanical elements used and a low power consumption level (10 mW-20 mW). More particularly, as the driving principle of liquid zooming is different from the aforementioned driving zooming principle using the motor, the liquid zooming does not require the lens moving elements and thus does not need to preserve the lens moving space. The U.S. Pat. No. 7,245,440 with the title “VARIABLE FOCAL LENS” of the Varioptic Company proposed a liquid zooming method of filling a lens with non-conductive silicon oil and a conductive aqueous solution. A zooming interface is formed between the aqueous solution and the silicon oil. Then, an electrowetting method is incorporated to control a liquid contacting angle, so as to perform zooming by adjusting a shape of the zooming interface. However, the liquid materials are hard to be managed such that many problems still present in the current liquid zooming driving mode. Firstly, environmental temperature enormously affects liquid zooming. In detail, once the temperature changes, the silicon oil and the water may each change its density and mix together, which results in coma. Moreover, by changing the liquid contacting angle with the applied voltage, the voltage applied may electrolyze the silicon oil and the water and result in degeneration of the silicon oil and the water. Furthermore, when adjusting the zooming interface, the silicon oil and the water moves and generates friction with an inner wall of the lens. After long period of operation, a hysteresis is generated between the silicon oil, the water and the inner wall of the lens, which leads to a problem of asymmetric zooming interface.

To improve the aforementioned issue, the U.S. Patent No. 2007/0199454 with the title “INSULATING SOLUTION FOR LIQUID LENS WITH HIGH RELIABILITY AND LIQUID LENS USING THE SAME” of the Samsung Company proposed a new silicon oil to alleviate the effect of liquid materials to zooming. However, this cannot completely solve the problem of the liquid lens that uses the liquid zooming.

### SUMMARY OF THE INVENTION

Accordingly, the present invention provides a liquid optical lens having an elastic membrane as an interface between a first liquid and a second liquid to reduce the effect of liquid materials on zooming.

The present invention also provides a liquid optical lens module having the aforementioned liquid optical lens and a volume adjustment mechanism. Through the volume adjustment mechanism, a volume ratio between a first liquid and a second liquid is well-adjusted and a focal length of the liquid optical lens is precisely changed. In light of the foregoing, the present invention provides a liquid optical lens, which includes a transparent container, an elastic membrane, a first liquid and a second liquid. The elastic membrane divides the transparent container into a first chamber and a second chamber. The first liquid fills the first chamber. The second liquid fills the second chamber. A curvature of the elastic membrane is regulated by changing the volume ratio between the first liquid and the second liquid so as to adjust the focal length of the liquid optical lens.

The present invention further provides a liquid optical lens module, which includes at least one liquid optical lens and at least one volume adjustment mechanism. The liquid optical lens includes a transparent container, an elastic membrane, a first liquid, and a second liquid. The elastic membrane divides the transparent container into a first chamber and a second chamber. The first liquid fills the first chamber. The second liquid fills the second chamber. The volume adjustment mechanism connects to the first chamber and the second chamber, and changes the volume ratio between the first liquid and the second liquid to regulate the curvature of the elastic membrane so as to adjust the focal length of the liquid optical lens.

In one embodiment of the present invention, the volume adjustment mechanism includes a liquid carrier, a bimorph device, a first pipe and a second pipe. The bimorph device is disposed within the liquid carrier and has a fixed end and a free end. The fixed end is connected to the liquid carrier while the free end moves back and forth along the interior of the liquid carrier. The bimorph device divides the liquid carrier into a first region and a second region. The first pipe connects the first region and the first chamber. The second pipe connects the second region and the second chamber. Volumes of the first region and the second region are changed through the back and forth movement of the bimorph device, such that a volume ratio between the first liquid and the second liquid in the transparent container is regulated.

In another embodiment of the present invention, the volume adjustment mechanism includes a liquid carrier, a spacer, an actuator, a first pipe and a second pipe. The liquid carrier has a pivot. The spacer is disposed within the liquid carrier and includes a pivotal end and a free end. The pivotal end is connected to the pivot while the free end moves back and forth along the interior of the liquid carrier. The spacer divides the liquid carrier into a first region and a second region. The actuator drives the spacer to rotate around the pivot, so that the spacer moves back and forth within the liquid carrier. The first pipe connects the first region and the first chamber. The second pipe connects the second region and the second chamber. Volumes of the first region and the second region are changed through the back and forth movement of the spacer, such that a volume ratio between the first liquid and the second liquid in the transparent container is regulated. The actuator may be a piezoelectric device. On the other hand, the actuator may also be a turning wheel mechanism, which includes a pivotal controller, a gear rack, a gear, and a turning wheel. The pivotal controller connects to the pivot. The gear rack connects to the pivotal controller. The gear is engaged with the gear rack. The turning wheel is engaged with the gear and its rotating direction is opposite to that of the gear.

In another embodiment of the present invention, the volume adjustment mechanism includes a liquid carrier, a piston device, a linkage, an actuator, a first pipe and a second pipe. The piston device is disposed within the liquid carrier and dividing the liquid carrier into a first region and a second region. The linkage has a pivotal end connected to the piston device, and a driving end. The actuator is connected to the driving end to drive the linkage. The first pipe connects the first region and the first chamber. The second pipe connects the second region and the second chamber. When the actuator drives the linkage, volumes of the first region and the second region are changed due to the back and forth movement of the piston device, thereby regulating a volume ratio between the first liquid and the second liquid in the transparent container.

In summary, the liquid optical lens of the present invention uses the elastic membrane as the interface between the first liquid and the second liquid, thereby preventing the first liquid and the second liquid from mixing due to temperature changes. In addition, the liquid optical lens module of the present invention utilizes the volume adjustment mechanism to modify the volume ratio between the first liquid and the second liquid, and consequently manipulates the curvature of the elastic membrane to achieve lens focusing. Different from the conventional electrowetting method, the present invention can reduce the effect of liquid materials on the lens curvature focusing and elevate its focusing performance. The liquid optical lens and the liquid optical lens module of the present invention have simple structures and can achieve nano-meter level demands.

In order to make the aforementioned and other features and advantages of the present invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A and FIG. 1B are perspective views of a liquid optical lens according to an embodiment of the present invention.

FIGS. 1C-1E are perspective views of another three types of liquid optical lenses according to an embodiment of the present invention.

FIG. 2 is a perspective view of a liquid optical lens module according to an embodiment of the present invention.

FIG. 3A is a perspective view of a liquid optical lens module according to a first embodiment of the present invention.

FIG. 3B is a side view and a magnified view of a volume adjustment mechanism in FIG. 3A.

FIG. 3C is a perspective structural view of a bimorph device according to an embodiment of the present invention.

FIG. 3D is perspective view of another liquid carrier according to an embodiment of the present invention.

FIG. 4A is a perspective view of a liquid optical lens module according to a second embodiment of the present invention.

FIG. 4B is a side view and a magnified view of a volume adjustment mechanism in FIG. 4A.

FIG. 4C is a magnified view of another volume adjustment mechanism according to an embodiment of the present invention.

FIG. 5A is a perspective view of a liquid optical lens module according to a third embodiment of the present invention.

FIG. 5B is a magnified view of a volume adjustment mechanism in FIG. 5A.

FIG. 6 is a perspective view of a liquid optical lens module according to a fourth embodiment of the present invention.

FIG. 7 is a perspective view of a liquid optical lens module according to a fifth embodiment of the present invention.

### DESCRIPTION OF EMBODIMENTS

A liquid optical lens and a liquid optical lens module in the present invention utilize an elastic membrane to divide a first liquid (silicon oil) and a second liquid (water). In addition, a volume adjustment mechanism is used to modify a volume ratio between the first liquid and the second liquid so as to adjust a curvature of the elastic membrane and change a focal length of the liquid optical lens as a consequence. A plurality of embodiments accompanied with drawings is described in the following to illustrate the liquid optical lens and the liquid optical lens module of the present invention in further detail.

### Liquid Optical Lens

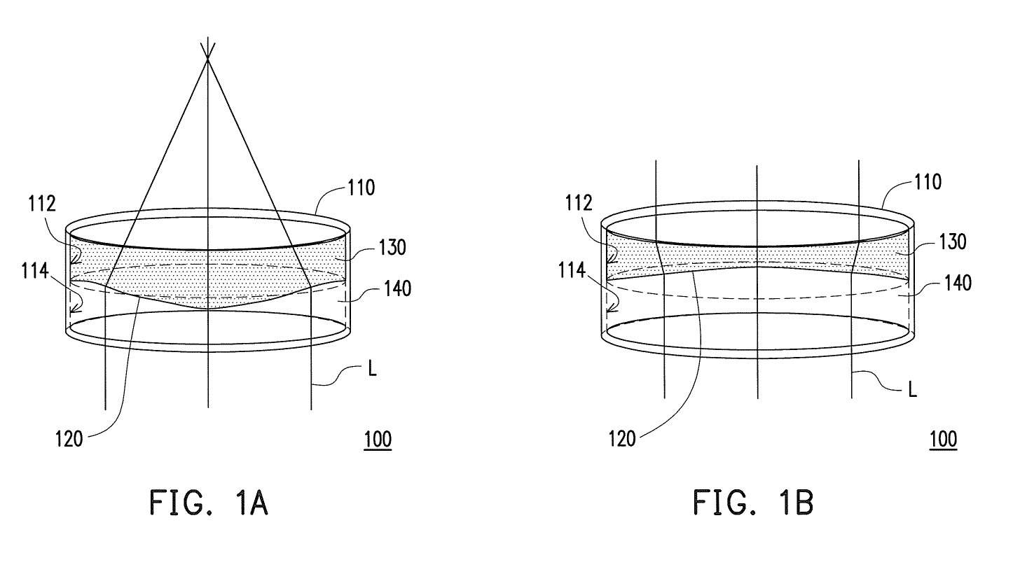

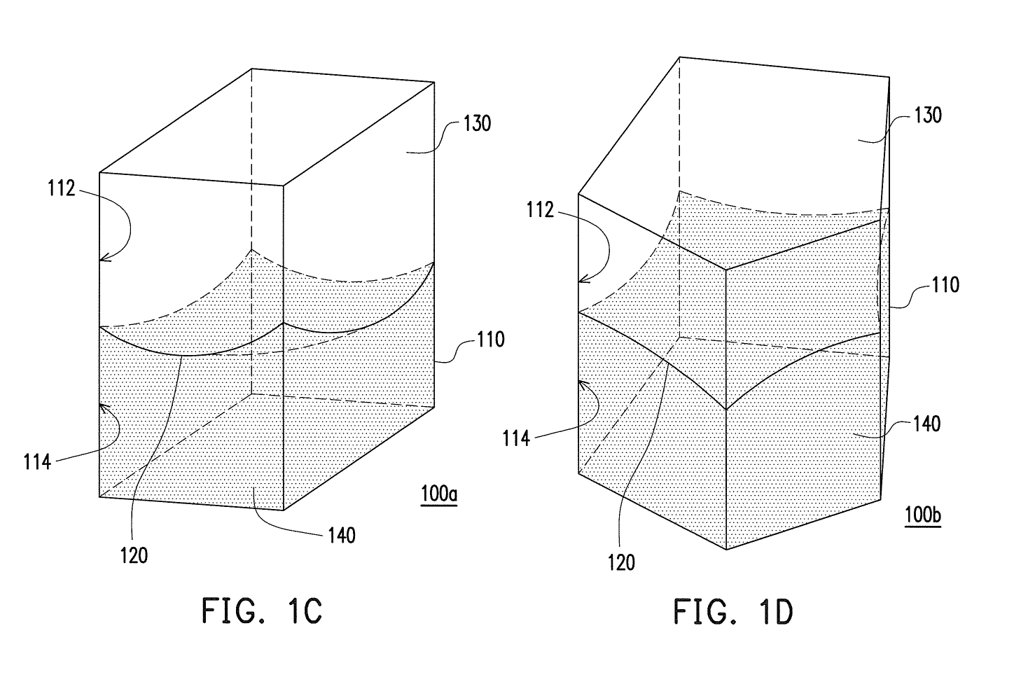

FIG. 1A and FIG. 1B are perspective views of a liquid optical lens according to an embodiment of the present invention. Referring to FIG. 1A, a liquid optical lens 100 includes a transparent container 110, an elastic membrane 120, a first liquid 130, and a second liquid 140. The elastic membrane 120 divides the transparent container 110 into a first chamber 112 and a second chamber 114. The first liquid 130 fills the first chamber 112. The second liquid 140 fills the second chamber 114. A curvature of the elastic membrane 120 is regulated by changing a volume ratio between the first liquid 130 and the second liquid 140 so as to adjust a focal length of the liquid optical lens 100.

Referring to FIG. 1A, when selecting a material for the elastic membrane 120, the degree of flexibility of the elastic membrane 120 must be considered. Moreover, the elastic membrane 120 must be able to sustain weights of the first liquid 130 and the second liquid 140 without being severely deformed. In preferred embodiment, the material of the elastic membrane 120 can be selected from polytetrafluomethylene (PTFE), polydimethylsiloxane (PDMS), or a combination thereof. Furthermore, the first liquid 130 may be silicon oil and the second liquid 140 may be water, that is, by cooperating liquids with different refractive indexes, a light beam L can be refracted in the liquid optical lens 100. The types of the first liquid 130 and the second liquid 140 are not limited herein.

It should be noted that when changing the volume ratio of the first liquid 130 and the second liquid 140, the liquid optical lens 100 may become a convex lens or a concave lens according to the curvature change of the elastic membrane 120. In detail, as illustrated in FIG. 1A, when a volume of the first liquid 130 is greater than a volume of the second liquid 140, the curvature of the elastic membrane 120 causes the liquid optical lens 100 to become a convex lens and allows the light beam L to be focused. As illustrated in FIG. 1B, when the volume of the first liquid 130 is smaller than the volume of the second liquid 140, the curvature of the elastic membrane 120 causes the liquid optical lens 100 to become a concave lens and allows the light beam L to be formed as parallel light beams.

FIGS. 1C-1E are perspective views of another three types of liquid optical lenses according to an embodiment of the present invention. Referring to FIGS. 1C-1E, the difference between liquid optical lenses 100a, 100b, 100c and the aforementioned liquid optical lens 100 is that shapes of the transparent containers 110 shown in FIG. 1A and FIG. 1B are cylindrical bodies, and shapes of the transparent container 110 of the liquid optical lenses 100a, 100b, and 100c are respectively a tetragonal pillar body (as shown in FIG. 1C), a pentagonal pillar body (as shown in FIG. 1D), or a hexagonal pillar body (as shown in FIG. 1E). The shape of the transparent container 110 can adopt suitable shapes to match up optical design requirements of the liquid optical lens 100. Hence, the shape of the transparent container 110 is not limited herein.

Accordingly, the liquid optical lenses 100, 100a, 100b, and 100c use the elastic membrane 120 to separate the first liquid 130 and the second liquid 140. Thus, the curvature of the elastic membrane 120 can be changed by regulating the volume ratio of the first liquid 130 and the second liquid 140 so as to adjust the focal length of the liquid optical lens 100. In comparison to a conventional movable optical lens, the liquid optical lenses 100, 100a, 100b, and 100c in the present invention do not require lens movement, hence, preserved space for lens movement is not necessary, which further satisfies the demand for miniaturization.

Moreover, compare to a conventional liquid optical lens that uses electrowetting method, the elastic membrane 120 in the present invention can separate the first liquid 130 and the second liquid 140. That is, the liquid optical lenses 100, 100a, 100b, and 100c are not affected by environmental temperature, and thus do not result all the problems of the conventional liquid optical lens using the electrowetting method. Moreover, the elastic membrane 120 is used as a zooming interface of the liquid optical lenses 100, 100a, 100b, and 100c. Therefore, hysteresis that results from the conventional electrowetting method and causes the zooming interface to be asymmetric will not occur.

### Liquid Optical Lens Module

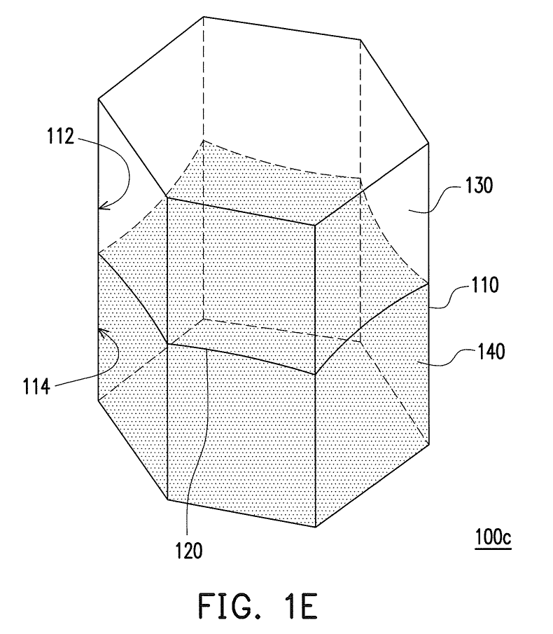

FIG. 2 is a perspective view of a liquid optical lens module according to an embodiment of the present invention. Referring to FIG. 2, a liquid optical lens module 300 includes at least one liquid optical lens 100 and at least one volume adjustment mechanism 200. The liquid optical lens 100 includes a transparent container 110, an elastic membrane 120, a first liquid 130, and a second liquid 140. The elastic membrane 120 divides the transparent container 110 into a first chamber 112 and a second chamber 114. The first liquid 130 fills the first chamber 112. The second liquid 140 fills the second chamber 114. The volume adjustment mechanism 200 is connected to the first chamber 112 and the second chamber 114, and is used to change a volume ratio between the first liquid 130 and the second liquid 140 to regulate a curvature of the elastic membrane 120 so as to adjust a focal length of the liquid optical lens 100. The volume adjustment mechanism 200 shown in FIG. 2 is merely exemplary. The following will continue to illustrate embodiments of volume adjustment mechanisms 200a-200d and disposition methods of the liquid optical lens 100 and the volume adjustment mechanism 200.

### First Embodiment

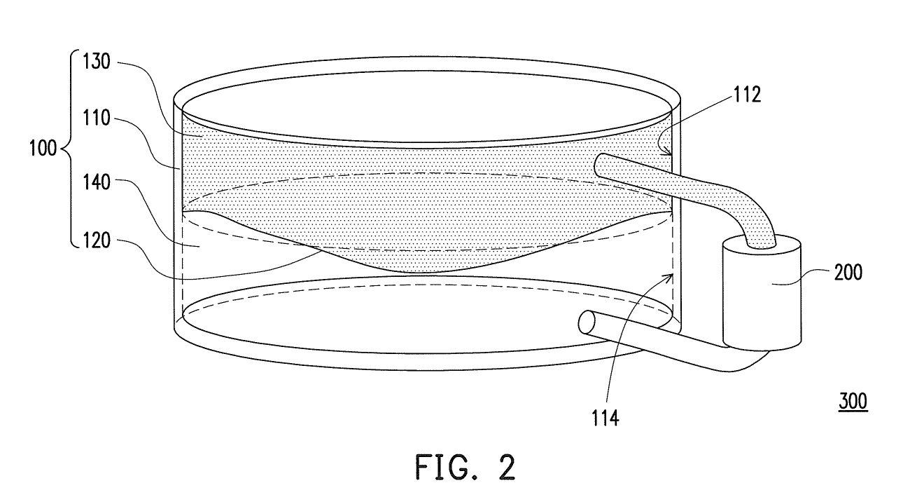

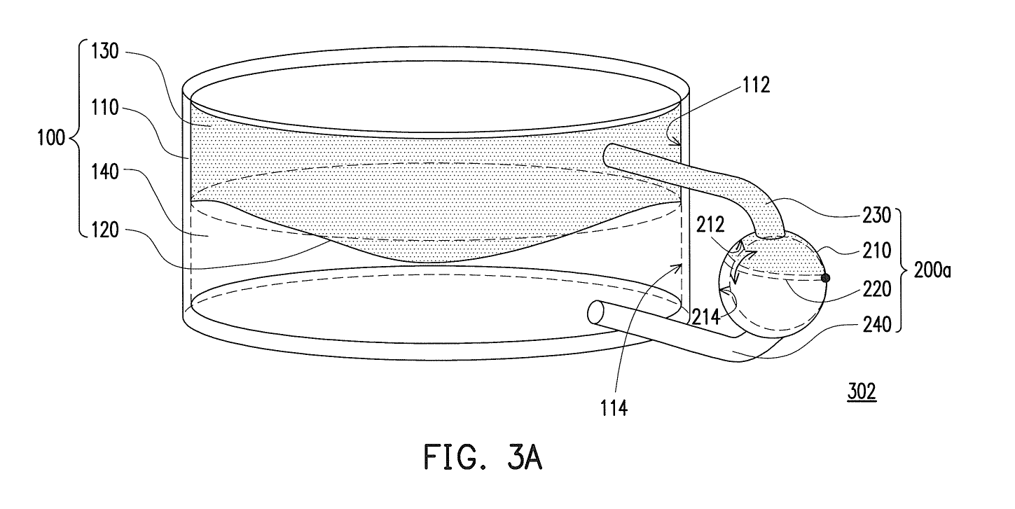

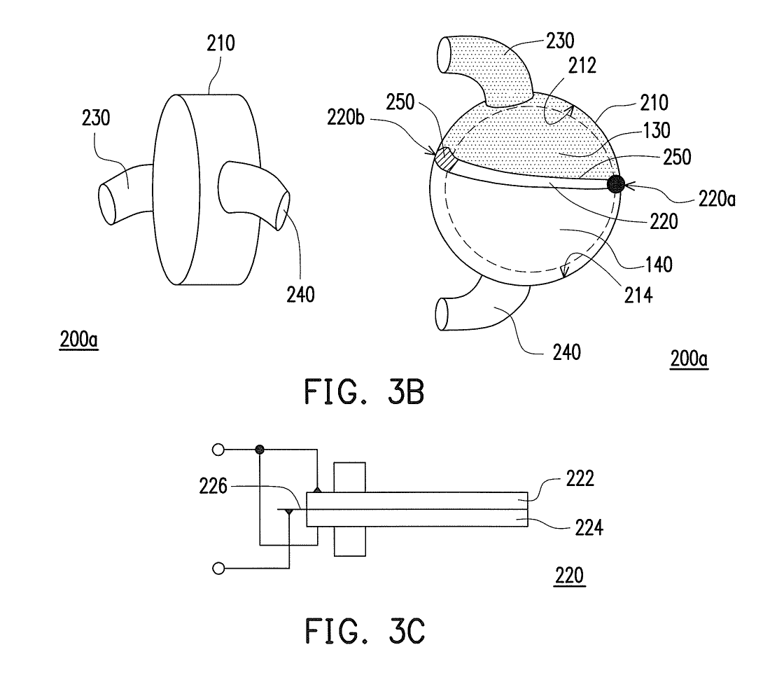

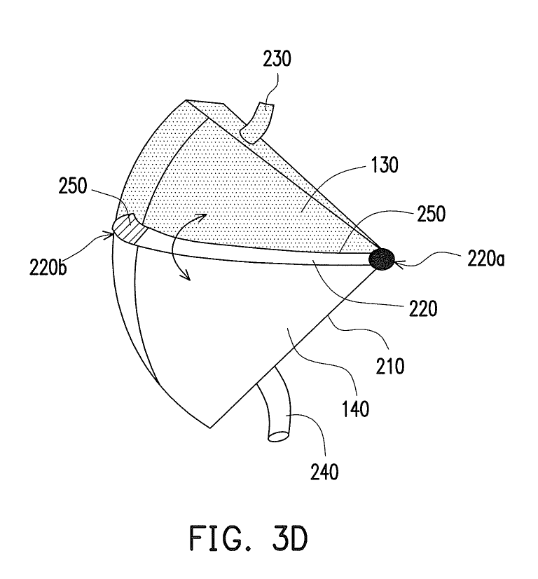

FIG. 3A is a perspective view of a liquid optical lens module according to a first embodiment of the present invention. FIG. 3B is a side view and a magnified view of a volume adjustment mechanism in FIG. 3A. In a liquid optical lens module 302, the same elements as those in FIG. 2 are labeled with the same numbers, thus the detailed structural composition will not be repeated herein. A volume adjustment mechanism 200a is illustrated in the following.

Referring to FIG. 3A and FIG. 3B, the volume adjustment mechanism 200a includes a liquid carrier 210, a bimorph device 220, a first pipe 230, and a second pipe 240. The bimorph device 220 is disposed within the liquid carrier 210 and has a fixed end 220a and a free end 220b. The fixed end 220a is connected to the liquid carrier 210 while the free end 220b moves back and forth along the interior of the liquid carrier 210. The bimorph device 220 divides the liquid carrier 210 into a first region 212 and a second region 214. The first pipe 230 connects the first region 212 and the first chamber 112. The second pipe 240 connects the second region 214 and the second chamber 114. Volumes of the first region 212 and the second region 214 are changed due to the back and forth movement of the bimorph device 220, such that a volume ratio between the first liquid 130 and the second liquid 140 in the transparent container 110 can be regulated.

Generally speaking, the bimorph device 220 is a device for mutual converting electrical energy and mechanical energy. When applying electrical energy to the bimorph device 220, the bimorph 220 deforms. FIG. 3C is a perspective structural view of a bimorph device according to an embodiment of the present invention. Referring to FIG. 3, the bimorph device 220 includes a first piezoelectric sheet 222, a second piezoelectric sheet 224, and a metallic elastic sheet 226. The metallic elastic sheet 226 is disposed between the first piezoelectric sheet 222 and the second piezoelectric sheet 224. When a voltage is applied on the first piezoelectric sheet 222 and the second piezoelectric sheet 224 through the metallic elastic sheet 226, the first piezoelectric sheet 222 and the second piezoelectric sheet 224 will be deformed. For example, when the second piezoelectric sheet 224 is contracted and the first piezoelectric sheet 222 is elongated, the bimorph device 220 will be curved and moved toward downside in the direction as shown of FIG. 3C. By the above principle, the bimorph device 220 can move back and forth. Here, the bimorph device 220 shown in FIG. 3C is only exemplary, bimorph devices of other designs may be applied as well and are thus not limited herein.

Hence, the voltage can be applied to the bimorph device 220 so that the free end 220b of the bimorph device 220 can move back and forth in the liquid carrier 210. As a result, the volume ratio of the first liquid 130 in the first region 212 and the second liquid 140 in the second region 214 will be changed. Because the first pipe 230 is connected between the first region 212 and the first chamber 112, and the second pipe 240 is connected between the second region 214 and the second chamber 114, the volume ratio of the first liquid 130 in the first chamber 112 and the second liquid 140 in the second chamber 114 is also changed. Therefore, weights of the first liquid 130 and the second liquid 140 sustained by the elastic membrane 120 will be changed, thereby causing the curvature of the elastic membrane 120 to be changed as well. Referring to FIG. 3B, a rubber layer 250 may be disposed on the bimorph device 220 to merely cover the free end 220b of the bimorph device 220. On the other hand, the rubber layer 250 may also cover the bimorph device 220 entirely (not shown here). The rubber layer 250 protects the bimorph device 220 from erosion by the first liquid 130 and the second liquid 140. Particularly, air tightness between the free end 224 of the bimorph device 220 and the liquid carrier 210 can also be increased by disposing the rubber layer 250 on the free end 220b, such that the first region 212 and the second region 214 of the liquid carrier 210 do not connect to each other. It should be noted that, different from the conventional electrowetting method of applying the voltage directly on the liquid material to change a liquid contacting angle, the aforementioned volume adjustment mechanism 200a uses the regulation of the volume ratio between the first liquid 130 and the second liquid 140 to adjust the curvature of the elastic membrane 120. Thus, the problem of the first liquid 130 and the second liquid 140 degeneration due to electrolysis will not occur.

FIG. 3D is a perspective view of another liquid carrier according to an embodiment of the present invention. Specifically, by changing the shapes of the liquid carrier 210, the air tightness between the free end 220b of the bimorph device 220 and the liquid carrier 210 can be increased, and the back and forth movement of the bimorph device 220 will result in greater changes in the volume ratio between the first region 212 and the second region 214. For example, instead of using the cylindrical body shown in FIG. 3B, the liquid carrier 210 can be formed as a sector body shown in FIG. 3D to achieve above needs.

### Second Embodiment

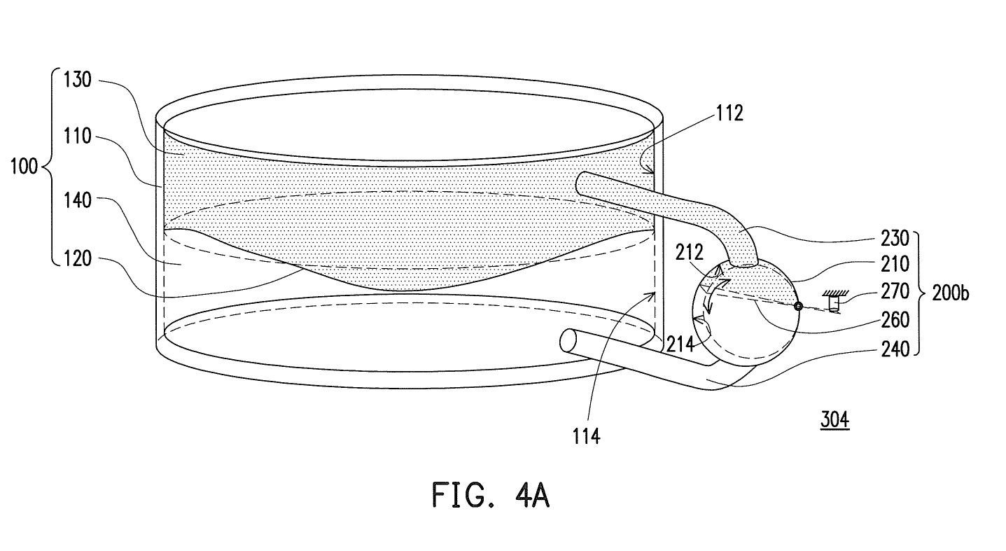

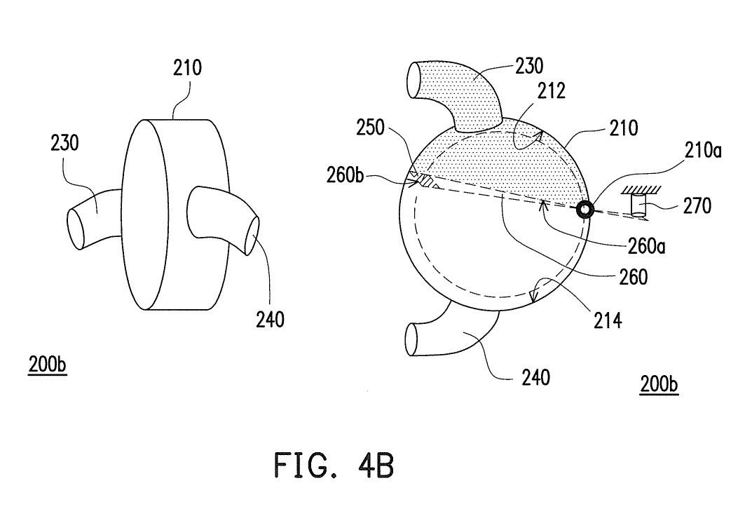

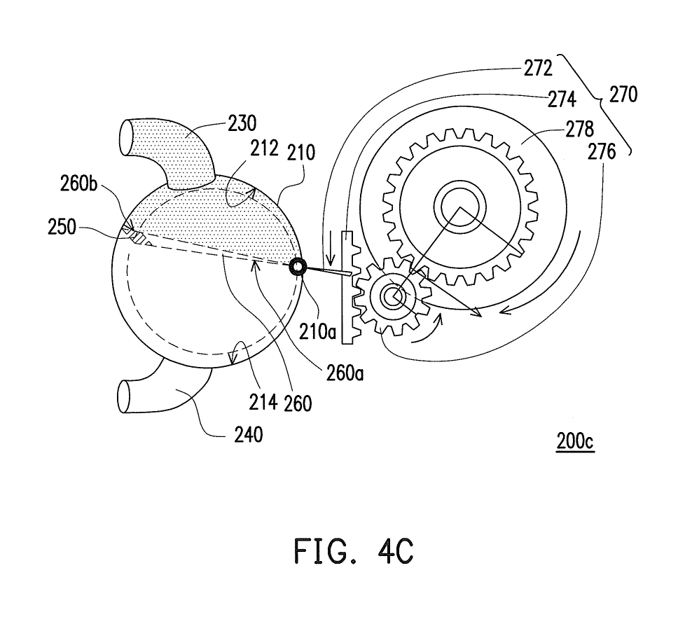

FIG. 4A is a perspective view of a liquid optical lens module according to a second embodiment of the present invention. FIG. 4B is a side view and a magnified view of a volume adjustment mechanism in FIG. 4A. In a liquid optical lens module 304, the same elements as those in FIG. 2 are labeled with the same numbers, thus the detailed structural composition will not be repeated herein. A volume adjustment mechanism 200b is illustrated in the following.

Referring to FIG. 4A and FIG. 4B simultaneously, the volume adjustment mechanism 200b includes a liquid carrier 210, a spacer 260, an actuator 270, a first pipe 230, and a second pipe 240. The liquid carrier 210 has a pivot 210a. The spacer 260 is disposed within the liquid carrier 210. The spacer 260 includes a pivotal end 260a and a free end 260b. The pivotal end 260a is connected to the pivot 210a, and the free end 260b moves back and forth along the interior of the liquid carrier 210. The spacer 260 divides the liquid carrier 210 into a first region 212 and a second region 214. The actuator 270 drives the spacer 260 to rotate around the pivot 210a, so that the spacer 260 moves back and forth within the liquid carrier 210. The first pipe 230 connects the first region 212 and a first chamber 112. The second pipe 240 connects the second region 214 and a second chamber 114. Here, volumes of the first region 212 and the second region 214 are changed by the back and forth movement of the spacer 260, such that a volume ratio between the first liquid 130 and the second liquid 140 in the transparent container 110 is regulated.

In embodiments in FIG. 4A and FIG. 4A, the spacer 260 can be the usual plastic sheet or other sheet with good elasticity. Similarly, the rubber layer 250 may also be used to merely cover the free end 260b of the spacer 260. On the other hand, the rubber layer 250 can be used to cover the spacer 260 entirely (not shown herein) to obtain good sealing effect and ensure the spacer 260 will not be corroded by the first liquid 130 and the second liquid 140.

Accordingly, the actuator 270 and the lever principle are utilized so that the spacer 260 rotates around the pivot 210a. As a consequence, the free end 260b of the spacer 260 can move back and forth along the liquid carrier 210 to change the volume ratio between the first liquid 130 in the first region 212 and the second liquid 140 in the second region 214. In an embodiment in FIG. 4B, the actuator 270 may be a piezoelectric device. By using the property of the piezoelectric device to elongate when a voltage is applied and recover when a voltage is not applied, the spacer 260 can be driven to move back and forth finely.

FIG. 4C is a magnified view of another volume adjustment mechanism according to an embodiment of the present invention. The difference between a volume adjustment mechanism 200c shown in FIG. 4C and the volume adjustment mechanism 200b shown in FIG. 4A is that the actuators 270 used are different. Referring to FIG. 4C, the actuator 270 can also apply a turning wheel mechanism, which includes a pivotal controller 272, a gear rack 274, a gear 276, and a turning wheel 278. The pivotal controller 272 is connected to the pivot 210a. The gear rack 274 is connected to the pivotal controller 272. The gear 276 is engaged with the gear rack 274. The turning wheel 278 is engaged with the gear 276 and its rotating direction is opposite to that of the gear 276. The turning wheel mechanism is used as the actuator 270 to adjust the extent of the back and forth movement of the spacer 260 more precisely. Hence, the curvature of the elastic membrane 120 can be fine tuned. Similarly, in a liquid optical lens module 304 illustrated in FIG. 4A, the shape designs of the liquid carrier 210 may also be altered to, for example, a cylindrical body or a sector body, etc. The details of the sector body have been illustrated in FIG. 3D and are thus not repeated herein.

### Third Embodiment

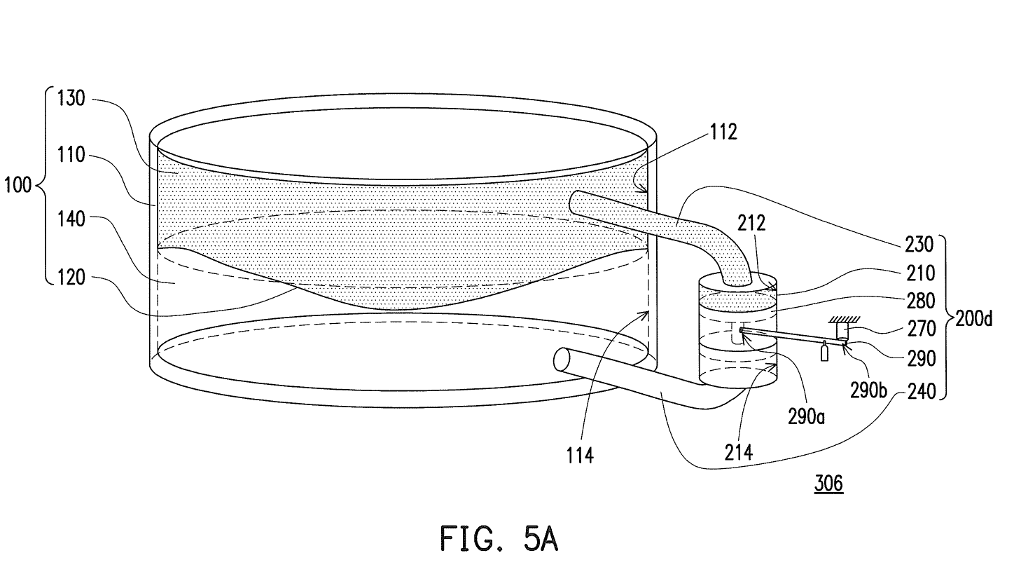

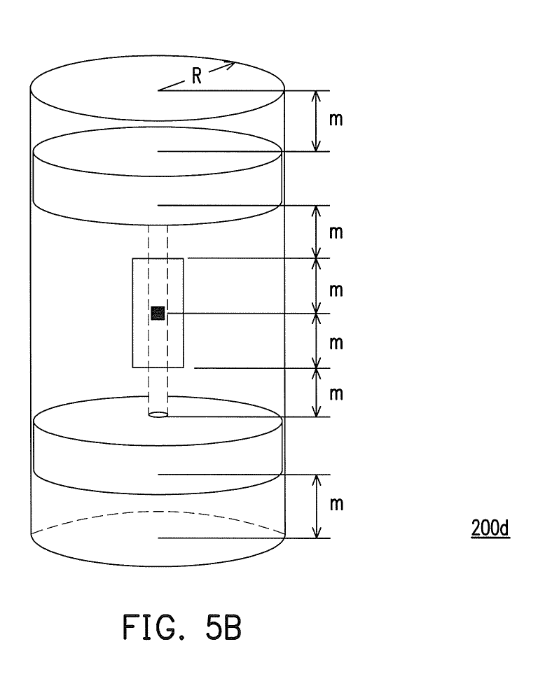

FIG. 5A is a perspective view of a liquid optical lens module according to a third embodiment of the present invention. FIG. 5B is a magnified view of a volume adjustment mechanism in FIG. 5A. In a liquid optical lens module 306, the same elements as those in FIG. 2 are labeled with the same numbers, thus the detailed structural composition will not be repeated herein. A volume adjustment mechanism 200d is illustrated in the following.

Referring to FIG. 5A and FIG. 5B, the volume adjustment mechanism 200d includes a liquid carrier 210, a piston device 280, a linkage 290, an actuator 270, a first pipe 230, and a second pipe 240. The piston device 280 is disposed within the liquid carrier 210 and divides the liquid carrier 210 into a first region 212 and a second region 214. The linkage 290 has a pivotal end 290a and a driving end 290b. The pivotal end 290a is connected to the piston device 280. The actuator 270 is connected to the driving end 290b to drive the linkage 290. The first pipe 230 connects the first region 212 and a first chamber 112. The second pipe 240 connects the second region 214 and a second chamber 114. When the actuator 270 drives the linkage 290, volumes of the first region 212 and the second region 214 are changed due to the back and forth movement of the piston device 280, thereby regulating a volume ratio between the first liquid 130 and the second liquid 140 in the transparent container 110.

Referring to FIG. 5A, the actuator 270 can apply the piezoelectric device, but is not limited herein. More particularly, as shown in FIG. 5B, a stroke distance m and a size of the radius R of the piston device 280 can be designed based on a desired curvature of an elastic membrane 120 to determine the greatest changing volume (πmR²) of the first region 212 and the second region 214.

Accordingly, by using one of the volume adjustment mechanisms 200a-200d, the volume ratio between the first liquid 130 and the second liquid 140 may be well regulated to change the curvature of the elastic membrane 120 so as to adjust the focal length of the liquid optical lens 100. Furthermore, the liquid optical lens modules 300-306 may include a control circuit (not shown), which is electrically connected to the volume adjustment mechanisms 200a-200d to regulate the operation of the volume adjustment mechanisms 200a-200d.

### Fourth Embodiment

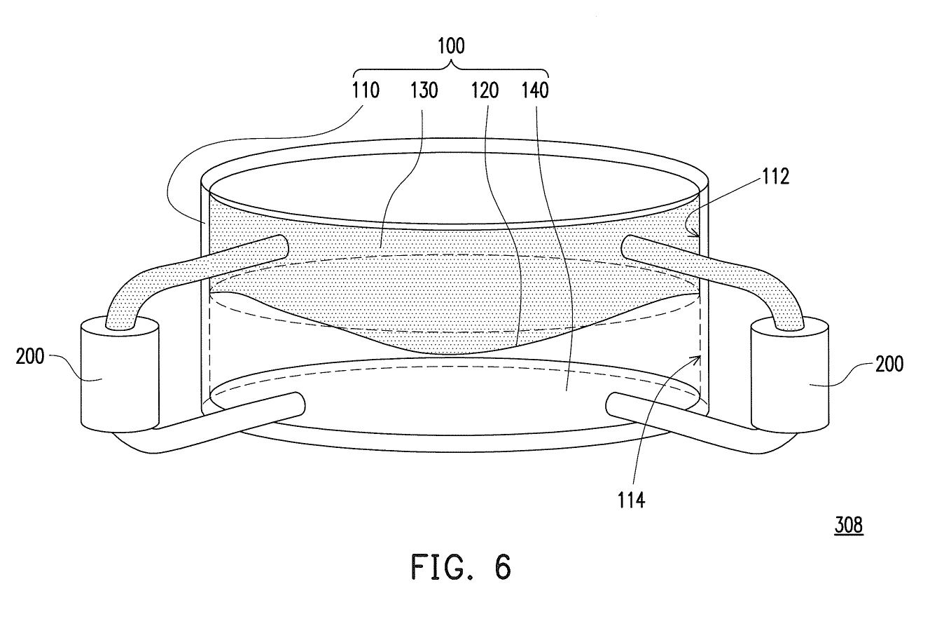

FIG. 6 is a perspective view of a liquid optical lens module according to a fourth embodiment of the present invention. Referring to FIG. 6, in a liquid optical lens module 308, volume adjustment mechanisms 200 are plural and are disposed in the periphery of the liquid crystal optical lens 100. FIG. 6 merely shows two volume adjustment mechanisms 200 as an example for illustration; however, the embodiment is not limited herein. When there is a plurality of volume adjustment mechanisms 200, the volume changing level of the first liquid 130 and the second liquid 140 can be elevated. When a curvature of an elastic membrane 120 needs to be adjusted in a great extent, a plurality of volume adjustment mechanisms 200 can be driven at the same time. The plurality of volume adjustment mechanisms 200 does not have to be driven simultaneously. More specifically, the control circuit (not shown) can be used to determine the quantity of the volume adjustment mechanisms 200 to be driven according to a desired volume changing level of the first liquid 130 and the second liquid 140.

### The Fifth Embodiment

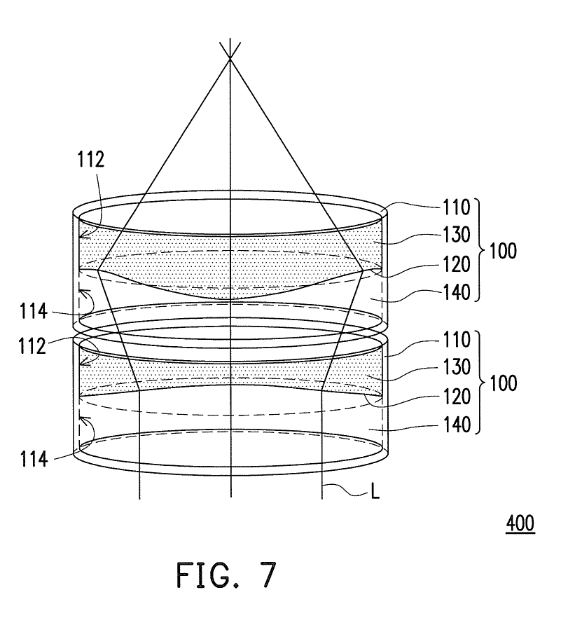

FIG. 7 is a perspective view of a liquid optical lens module according to a fifth embodiment of the present invention. Referring to FIG. 7, in a liquid optical lens module 400, a plurality of liquid optical lenses 100 aforementioned may also be used, such that the liquid optical lenses 100 can be stacked to form a zoom lens. Moreover, one of the volume adjustment mechanisms 200a-200d (not shown in FIG. 7) can be utilized to respectively adjust the curvature of the elastic membrane 120 in the different liquid optical lenses 100. As shown in FIG. 7, the liquid optical lens 100 above will be a convex lens, and the liquid optical lens 100 below will be a concave lens. The convex lens and the concave lens can then constitute a zoom lens to perform zooming of the light beam L. The flexibility of the optical design of the liquid optical lens module 400 is quite high. Though this embodiment only shows two liquid optical lenses 100 being stacked, it is not limited herein.

In summary, the liquid optical lens of the present invention uses the elastic membrane as the interface between the first liquid and the second liquid, thereby preventing the first liquid and the second liquid from mixing due to temperature changes. Moreover, the liquid optical lens module uses the volume adjustment mechanism to regulate the volume ratio between the first liquid and the second liquid to manipulate the curvature of the elastic membrane so as to establish lens focusing. Different from the conventional electrowetting method, the present invention can reduce the effect of the liquid material on lens curvature focusing. In addition, the liquid optical lens and the liquid optical lens module of the present invention have simple structures and can accomplish nano-meter level demands. Furthermore, the flexibility of the optical design is high as a plurality of liquid optical lenses and a plurality of volume adjustment mechanisms can be cooperated according to the optical design requirements.

Although the present invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A liquid optical lens, comprising:
a transparent container;
an elastic membrane, dividing the transparent container into a first chamber and a second chamber;
a first liquid, filling the first chamber; and
a second liquid, filling the second chamber;
wherein a curvature of the elastic membrane is regulated by changing a volume ratio between the first liquid and the second liquid so as to adjust a focal length of the liquid optical lens.

2. The liquid optical lens as claimed in claim 1, wherein the material of the elastic membrane is selected from polytetrafluoroethylene (PTFE), polydimethylsioxane (PDMS), and a combination thereof.

3. The liquid optical lens as claimed in claim 1, wherein the first liquid comprises silicon oil, and the second liquid comprises water.

4. The liquid optical lens as claimed in claim 1, wherein the liquid optical lens is a convex lens or a concave lens according to the curvature change of the elastic membrane.

5. The liquid optical lens as claimed in claim 1, wherein the transparent container comprises a cylindrical body or a polygonal pillar body.

6. A liquid optical lens module, comprising:
at least one liquid optical lens, comprising:
a transparent container;
an elastic membrane, dividing the transparent container into a first chamber and a second chamber;
a first liquid, filling the first chamber; and
a second liquid, filling the second chamber; and
at least one volume adjustment mechanism, connected to the first chamber and the second chamber, and changing a volume ratio between the first liquid and the second liquid to regulate a curvature of the elastic membrane so as to adjust a focal length of the liquid optical lens.

7. The liquid optical lens module as claimed in claim 6, wherein the volume adjustment mechanism comprises:
a liquid carrier;
a bimorph device, disposed within the liquid carrier and having a fixed end and a free end, wherein the fixed end is connected to the liquid carrier, the free end moves back and forth along the interior of the liquid carrier, and the bimorph device dividing the liquid carrier into a first region and a second region;
a first pipe, connecting the first region and the first chamber; and
a second pipe, connecting the second region and the second chamber;
wherein volumes of the first region and the second region are changed due to the back and forth movement of the bimorph device, thereby regulating the volume ratio between the first liquid and the second liquid in the transparent container.

8. The liquid optical lens module as claimed in claim 7, wherein the bimorph device comprises:
a first piezoelectric sheet;
a second piezoelectric sheet; and
a metallic elastic sheet, disposed between the first piezoelectric sheet and the second piezoelectric sheet;
wherein a voltage is applied on the first piezoelectric sheet and the second piezoelectric sheet through the metallic elastic sheet so as to deform the first piezoelectric sheet and the second piezoelectric sheet, such that the second piezoelectric sheet condenses when the first piezoelectric sheet elongates.

9. The liquid optical lens module as claimed in claim 7, further comprising a rubber layer, covering the free end of the bimorph device.

10. The liquid optical lens module as claimed in claim 7, further comprising a rubber layer, covering the whole bimorph device.

11. The liquid optical lens module as claimed in claim 7, wherein the liquid carrier comprises a cylindrical body or a sector body.

12. The liquid optical lens module as claimed in claim 6, wherein the volume adjustment mechanism comprises:
a liquid carrier, having a pivot;
a spacer, disposed within the liquid carrier and having a pivotal end and a free end, wherein the pivotal end is connected to the pivot, the free end moves back and forth along the interior of the liquid carrier, and the spacer dividing the liquid carrier into a first region and a second region;
an actuator, driving the spacer to rotate around the pivot, so that the spacer moves back and forth within the liquid carrier;
a first pipe, connecting the first region and the first chamber; and
a second pipe, connecting the second region and the second chamber;
wherein the volumes of the first region and the second region are changed due to the back and forth movement of the spacer, thereby regulating the volume ratio between the first liquid and the second liquid in the transparent container.

13. The liquid optical lens module as claimed in claim 12, wherein the actuator comprises a piezoelectric device.

14. The liquid optical lens module as claimed in claim 12, wherein the actuator is a turning wheel mechanism, comprises:
a pivotal controller, connected to the pivot;
a gear rack, connected to the pivotal controller;
a gear, engaged with the gear rack; and
a turning wheel, engaged with the gear and having an rotating direction opposite to a rotating direction of the gear.

15. The liquid optical lens module as claimed in claim 12, further comprising a rubber layer, covering the free end of the spacer.

16. The liquid optical lens module as claimed in claim 12, further comprising a rubber layer, covering the whole spacer.

17. The liquid optical lens module as claimed in claim 12, wherein the liquid carrier comprises a cylindrical body or a sector body.

18. The liquid optical lens module as claimed in claim 6, wherein the volume adjustment mechanism comprises:
a liquid carrier;
a piston device, disposed within the liquid carrier and dividing the liquid carrier into a first region and a second region;
a linkage, having a pivotal end connected to the piston device and a driving end;
an actuator, connected to the driving end to drive the linkage;
a first pipe, connecting the first region and the first chamber; and
a second pipe, connecting the second region and the second chamber;
wherein the volumes of the first region and the second region are changed due to the back and forth movement of the piston device when the actuator drives the linkage, thereby regulating the volume ratio between the first liquid and the second liquid in the transparent container.

19. The liquid optical lens module as claimed in claim 18, wherein the actuator comprises a piezoelectricity device.

20. The liquid optical lens module as claimed in claim 6, wherein a material of the elastic membrane is selected from polytetra-fluoroethylene (PTFE), polydimethylsioxane (PDMS), and a combination thereof.

21. The liquid optical lens module as claimed in claim 6, wherein the first liquid comprises silicon oil and the second liquid comprises water.

22. The liquid optical lens module as claimed in claim 6, wherein the liquid optical lens is a convex lens or a concave lens according to the curvature change of the elastic membrane.

23. The liquid optical lens module as claimed in claim 6, wherein the transparent container comprises a cylindrical body or a polygonal pillar body.

24. The liquid optical lens module as claimed in claim 6, wherein the volume adjustment mechanisms are plural and disposed in the periphery of the liquid optical lens.

25. The liquid optical lens module as claimed in claim 6, wherein the liquid optical lenses are plural, the plurality of liquid optical lenses are stacked to form a zoom lens.

26. The liquid optical lens module as claimed in claim 6, further comprising a control circuit, electrically connected to the volume adjustment mechanism.
